(19) United States
(12) Patent Application Publication
(10) Pub. No.: US 2024/0094897 A1
(43) Pub. Date: Mar. 21, 2024

(54) DEVICE AND CONTROL METHOD ABOUT LAYOUT IN GRAPHIC USER INTERFACE

(71) Applicant: HTC Corporation, Taoyuan City (TW)

(72) Inventor: Yi-Hsin CHANG, Taoyuan City (TW)

(21) Appl. No.: 17/934,191

(22) Filed: Sep. 21, 2022

(51) Int. Cl. G06F 3/04883; G06F 3/0484

(52) U.S. Cl. CPC G06F 3/04883; G06F 3/0484

(57) ABSTRACT

A control method, for controlling a graphic user interface displayed on a touch display panel, includes following steps. A continuous contact trace is tracked by the touch display panel corresponding to a finger on the touch display panel. An interaction layout is allocated within the graphic user interface according to the continuous contact trace. A size configuration of the interaction layout is scaled within the graphic user interface according to the continuous contact trace.

### BACKGROUND

### Field of Invention

The disclosure relates to control method for controlling a graphic user interface. More particularly, the disclosure is about positioning and scaling an interaction layout in the graphic user interface.

### Description of Related Art

A touch display panel is a common input-output component on a mobile device, such as a smartphone. The touch display panel is able to show some information, images and/or functional keys on a graphic user interface. In order to provide more information at one glance and a better experience while watching videos, a size of the touch display panel become bigger and bigger on a modern smartphone. Most people are not able reach the edge of the touch display panel with their thumbs when they hold the mobile device in one hand.

Touch display panels on different devices may have different sizes, and also human hands have different sizes. If the graphic user interface is drawn with a fixed ratio, people with small hands will not be able to reach a desired function key on a larger touch display panel, and people with large hands will have an awkward user experience on a smaller touch display panel.

### SUMMARY

The disclosure provides a control method for controlling a graphic user interface displayed on a touch display panel. The control method includes following steps. A continuous contact trace is tracked by the touch display panel corresponding to a finger on the touch display panel. An interaction layout is allocated within the graphic user interface according to the continuous contact trace. A size configuration of the interaction layout is scaled within the graphic user interface according to the continuous contact trace.

The disclosure also provides a non-transitory computer readable storage medium with a computer program. The computer program is configured to execute aforesaid control method.

The disclosure also provides an electronic device, which includes a touch display panel and a controller. The touch display panel is configured to display a graphic user interface and track a continuous contact trace corresponding to a finger. The controller is coupled with the touch display panel. The controller is configured to allocate an interaction layout within the graphic user interface according to the continuous contact trace. The controller is configured to scale a size configuration of the interaction layout within the graphic user interface according to the continuous contact trace.

It is to be understood that both the foregoing general description and the following detailed description are demonstrated by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an electronic device according to an embodiment of the disclosure.

FIG. 2 is a schematic diagram illustrating a graphic user interface displayed on a touch display panel in FIG. 1.

FIG. 3A is a schematic diagram illustrating an interaction layout displayed within the graphic user interface in some embodiments.

FIG. 3B is a schematic diagram illustrating another interaction layout displayed within the graphic user interface in some other embodiments.

FIG. 4 is a flowchart illustrating a control method according to some embodiments of the disclosure.

FIG. 5A to FIG. 5C are schematic diagrams illustrating three different continuous contact traces corresponding to the finger.

FIG. 6 is a flowchart illustrating a control method according to some embodiments of the disclosure.

FIG. 7A is a schematic diagram illustrating the reachable area determined by the controller corresponding to the continuous contact trace in FIG. 5A.

FIG. 7B is a schematic diagram illustrating the interaction layout allocated and scaled according to the reachable area RA1 in FIG. 7A in some embodiments.

FIG. 7C is a schematic diagram illustrating the interaction layout in some embodiments.

FIG. 8A is a schematic diagram illustrating the reachable area determined by the controller corresponding to the continuous contact trace in FIG. 5B.

FIG. 8B is a schematic diagram illustrating the interaction layout allocated and scaled according to the reachable area in FIG. 8A in some embodiments.

FIG. 9 is a flowchart illustrating a control method according to some embodiments of the disclosure.

FIG. 10A is a schematic diagram illustrating the circular curve corresponding to the continuous contact trace.

FIG. 10B is a schematic diagram illustrating the interaction layout allocated and scaled according to the circular center and the radius length in FIG. 10A in some embodiments.

FIG. 11A is a schematic diagram illustrating the circular curve corresponding to the continuous contact trace.

FIG. 11B is a schematic diagram illustrating the interaction layout allocated and scaled according to the circular center and the radius length in FIG. 11A in some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

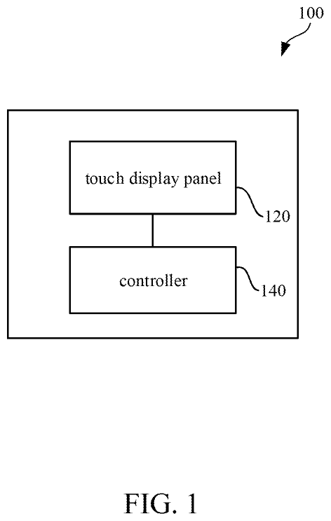

Reference is made to FIG. 1, which is a schematic diagram illustrating an electronic device 100 according to an embodiment of the disclosure. As shown in FIG. 1, the electronic device 100 includes a touch display panel 120 and a controller 140. The controller 140 is coupled with the touch display panel 120.

In some embodiments, the electronic device 100 can be a smartphone, a tablet computer or a similar mobile device. In some embodiments, the touch display panel 120 can be implemented by an integrated touchscreen or a combination of a display panel and a touch module disposed adjacent to the display panel. In some embodiments, the controller 140 can be implemented by a central processing unit (CPU), a graphic processing unit (GPU), a tensor processing unit (TPU), an application specific integrated circuit (ASIC) or a similar processor circuit in the electronic apparatus 100.

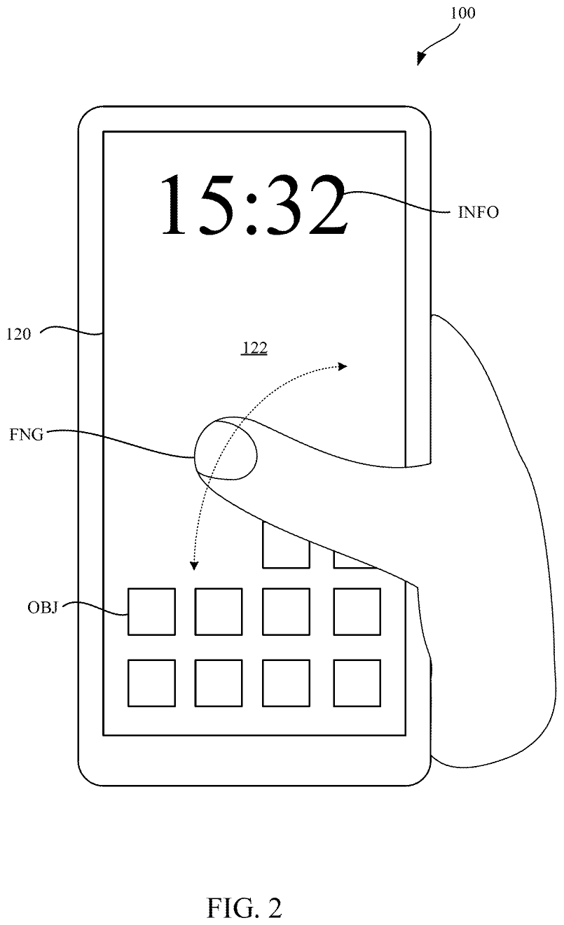

In some embodiments, the touch display panel 120 is configured to show a graphic user interface and collect touch input events (e.g., contact points or contact routes by a finger of a user) on the touch display panel 120. FIG. 2 is a schematic diagram illustrating a graphic user interface 122 displayed on a touch display panel 120 in FIG. 1. As shown in FIG. 2, the graphic user interface 122 is displayed on the touch display panel 120. The graphic user interface 122 may include some information INFO, such as time readings as shown in FIG. 2, and some objects OBJ, such as some application icons as shown in FIG. 1. When a user holds the electronic device 100 in one hand, a finger FNG can perform a touch contact on the touch display panel 120, and interacts with items on the graphic user interface 122. Based on a hand gesture performed by the finger FNG on the touch display panel 120, the graphic user interface 122 in some embodiments will show a corresponding interaction layout.

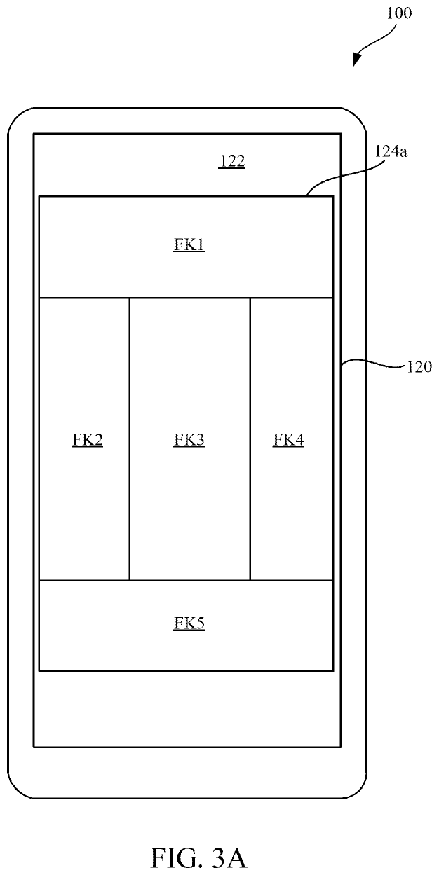

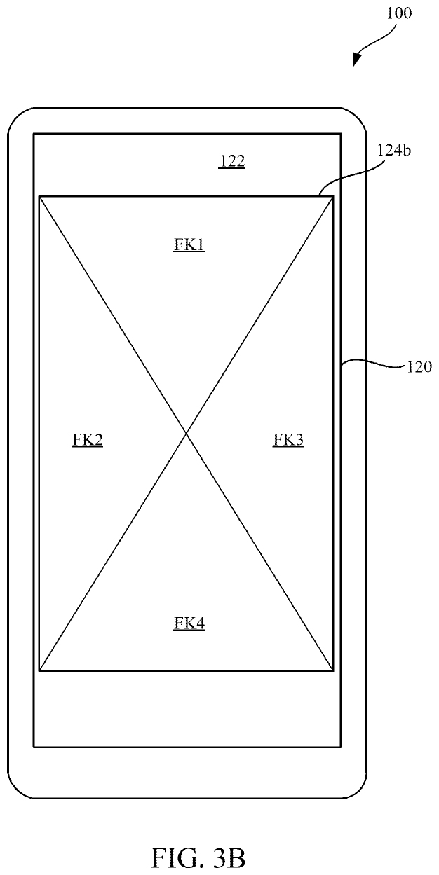

Reference is further made to FIG. 3A, which is a schematic diagram illustrating an interaction layout 124a displayed within the graphic user interface 122 in some embodiments. For example, when the finger FNG performs a long press (or press-and-hold) or a double-tap, it will trigger the touch display panel 120 to display the interaction layout 124a within the graphic user interface 122. As shown in FIG. 3A, the interaction layout 124a can be a functional menu, which include five functional keys FK1-FK5 corresponding to different applications or functions. In some examples, the functional keys FK1-FK5 can be launching shortcuts of different program applications, such as email, social media, music player, camera and web browser. In some examples, the functional keys FK1-FK5 can be functional buttons, such as increasing/decreasing brightness, increasing/decreasing sound volume, or switching on/off a power saving mode.

As shown in FIG. 3A, the interaction layout 124a is in a rectangular shape. The functional key FK1 is located around a top edge of the interaction layout 124a. The functional key FK5 is located around a bottom edge of the interaction layout 124a. The functional keys FK2, FK3 and FK4 are located vertically between the functional keys FK1 and FK5 and horizontally from a left side to a right side of the interaction layout 124a.

It is noticed that, a configuration of functional keys in the interaction layout in this disclosure is not limited to the five functional keys FK1-FK5 as shown in FIG. 3A.

Reference is further made to FIG. 3B, which is a schematic diagram illustrating an interaction layout 124b displayed within the graphic user interface 122 in some other embodiments. As shown in FIG. 3B, the interaction layout 124b include four functional keys FK1-FK4. As shown in FIG. 3B, the interaction layout 124b is in a rectangular shape. As shown in FIG. 3B, the interaction layout 124b is divided into four regions by two diagonal lines. The functional key FK1 is located on a top side relative to two diagonal lines. The functional key FK2 is located on a left side relative to two diagonal lines. The functional key FK3 is located on a right side relative to two diagonal lines. The functional key FK4 is located on a bottom side relative to two diagonal lines.

The interaction layout 124a in FIG. 3A and the interaction layout 124b in FIG. 3B illustrate two possible embodiments. For brevity, the interaction layout 124a in FIG. 3A is utilized in the following discussions for demonstration. It is understood that the interaction layout 124a in the following discussion can be replaced by the interaction layout 124b or other similar interaction layouts.

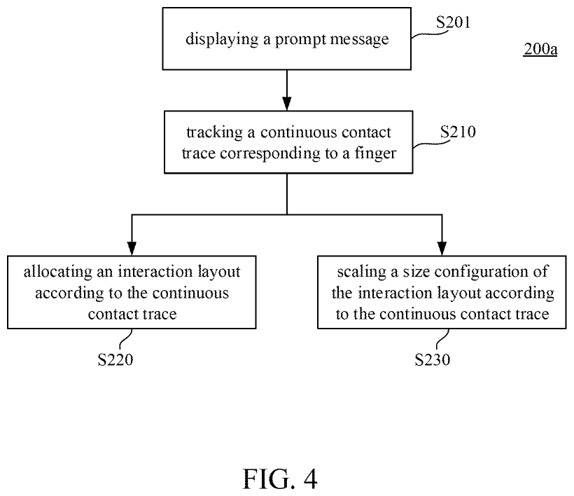

In some embodiments, it is desired that the user can manipulate the functional keys FK1-FK5 on the interaction layout 124a on one finger FNG (referring to FIG. 2). However, if a size of the interaction layout 124a and a position of the interaction layout 124a are fixed within the graphic user interface 122 as shown in FIG. 3A, it will be difficult for the user to reach some functional keys on the interaction layout 124a with the finger FNG. Therefore, some embodiments of this disclosure provide a control method to adjust the interaction layout 124a based on a touch input corresponding to the finger FNG on the touch display panel 120. Reference is further made to FIG. 4, which is a flowchart illustrating a control method 200a according to some embodiments of the disclosure.

At first, as shown in FIG. 4, step S201 is executed by the touch display panel 120, to display a prompt message on the graphic user interface 122. The prompt message is configured to suggest the user to move the finger FNG to draw a reachable boundary on the touch display panel 120. Then, step S210 is executed by the touch display panel 120, to track a continuous contact trace corresponding to the finger FNG.

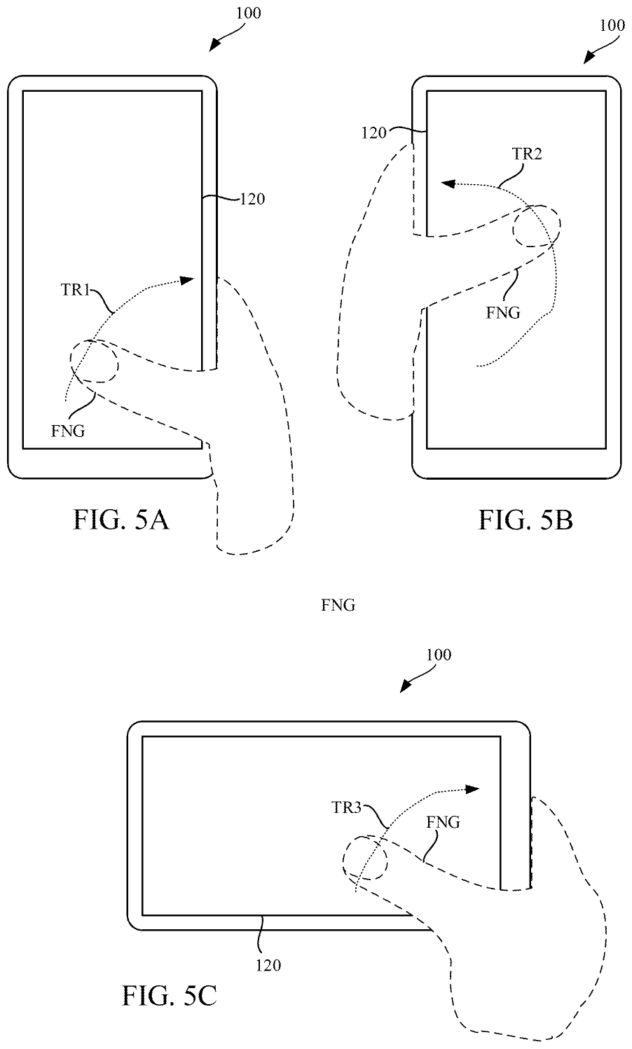

Reference is further made to FIG. 5A to FIG. 5C, which are schematic diagrams illustrating three different continuous contact traces TR1, TR2 and TR3 corresponding to the finger FNG. As shown in FIG. 5A to FIG. 5C, these continuous contact traces TR1, TR2 and TR3 tracked in the step S210 will be different based on how the user holds the electronic device 100 and also a length of the finger FNG (corresponding to a size of the user's hand).

In the embodiment shown in FIG. 5A, the user holds the electronic device 100 vertically around the right-bottom corner of the electronic device 100 with the right hand. The continuous contact trace TR1 is tracked by the touch display panel 120 while the finger FNG (i.e., the right thumb) drawing the reachable boundary. In this case, the continuous contact trace TR1 may indicate that the finger FNG can comfortably reach a right-bottom portion of the graphic user interface 122 in a view point of FIG. 5A.

In the embodiment shown in FIG. 5B, the user holds the electronic device 100 vertically around the left-middle edge of the electronic device 100 with the left hand. The continuous contact trace TR2 is tracked by the touch display panel 120 while the finger FNG (i.e., the left thumb) drawing the reachable boundary. In this case, the continuous contact trace TR2 may indicate that the finger FNG can comfortably reach a left-middle portion of the graphic user interface 122 in a view point of FIG. 5B.

In the embodiment shown in FIG. 5C, the user holds the electronic device 100 horizontally around the right-bottom corner of the electronic device 100 with the right hand. The continuous contact trace TR3 is tracked by the touch display panel 120 while the finger FNG (i.e., the left thumb) drawing the reachable boundary. In this case, the continuous contact trace TR3 may indicate that the finger FNG can comfortably reach a right-bottom portion of the graphic user interface 122 in a view point of FIG. 5C.

The continuous contact traces TR1-TR3 shown in FIG. 5A to FIG. 5C are illustrated for demonstration. In some other embodiments, when the user holds the electronic device 100 with different ways or when the user's hand in different sizes, the continuous contact trace will vary correspondingly.

Based on the size of the user's hand and how the user holds the electronic device 100 as illustrated in FIG. 5A to FIG. 5C, a corresponding continuous contact trace (for example, one of the continuous contact traces TR1-TR3) will be traced by the touch display panel 120 and transmitted to the controller 140.

In some embodiments, the controller 140 is configured to analyze the continuous contact trace TR1, TR2 or TR3, and adjust the interaction layout 124a based on the continuous contact trace.

Step S220 is executed by the controller 140, to allocate the interaction layout 124a within the graphic user interface 122 according to the continuous contact trace TR1, TR2 or TR3. In some embodiments, the interaction layout 124a will be allocated by the controller to be adjacent to the continuous contact trace. Step S230 is executed by the controller 140, to scale a size configuration of the interaction layout 124a within the graphic user interface 122 according to the continuous contact trace TR1, TR2 or TR3. In some embodiments, the size of interaction layout 124a will be enlarged or shrunk to a size in reference with the continuous contact trace. Further details about steps S220 and S230 are discussed below.

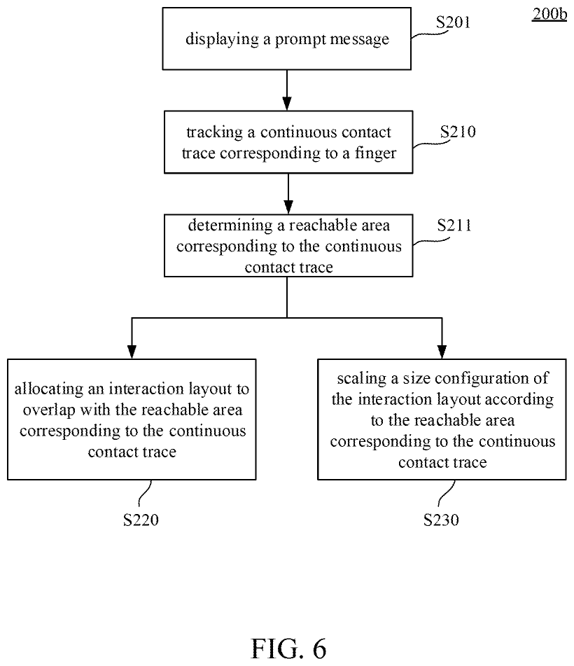

Reference is further made to FIG. 6, which is a flowchart illustrating a control method 200b according to some embodiments of the disclosure. The control method 200b in FIG. 6 illustrates an exemplary approach to perform the control method 200a in FIG. 4. The steps S201 and S210 in the control method 200b in FIG. 6 are similar to the steps S201 and S210 as discussed above. As shown in FIG. 6, after step S210, step S211 is executed by the controller 140 to analyze the continuous contact trace (e.g., TR1, TR2 or TR3) determine a reachable area according to the continuous contact trace.

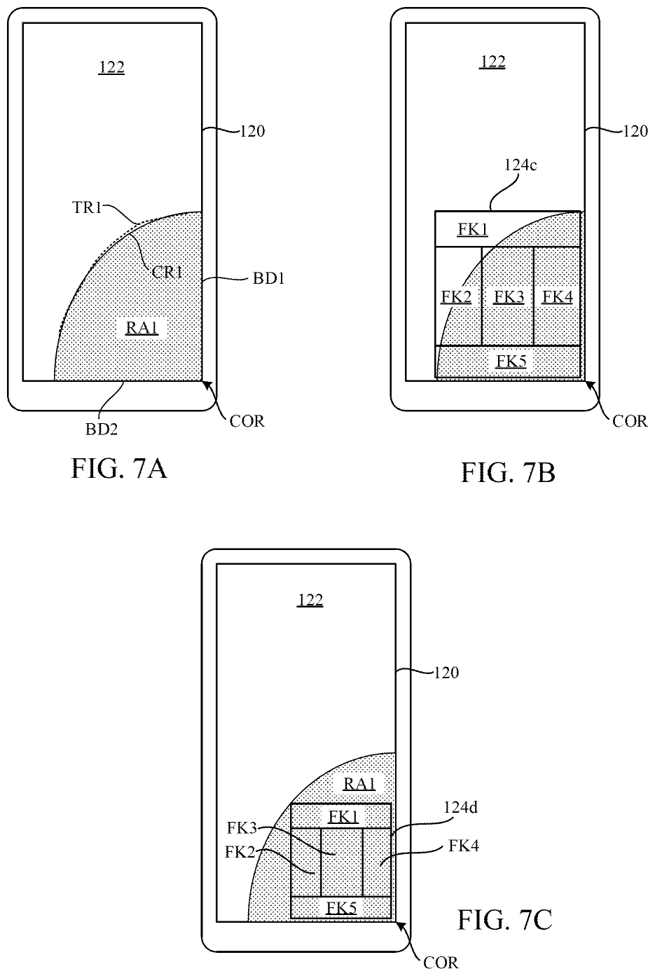

It is assumed that the continuous contact trace TR1 in FIG. 5A is tracked by the touch display panel 120 in step S210. In this case, the controller 140 is configured to draw a reachable area based on the continuous contact trace TR1. Reference is further made to FIG. 7A, which is a schematic diagram illustrating the reachable area RA1 determined by the controller 140 corresponding to the continuous contact trace TR1 in FIG. 5A.

As shown in FIG. 7A, in some embodiments, the reachable area RA1 is determined by fitting the continuous contact trace TR1 into a circular curve CR1 and extending the circular curve CR1 to boundaries BD1 and BD2 of the graphic user interface 122 to form a closed loop. In some embodiments, the continuous contact trace TR1 can be into a circular curve CR1 based on a curve-fitting algorithm. In this case, a top end of the circular curve CR1 is extended to the right boundary BD1 of the graphic user interface 122, and a bottom end of the circular curve CR1 is extended to the bottom boundary BD2 of the graphic user interface 122. An area within the closed loop is determined as the reachable area RA1. In this case, according to the continuous contact trace TR1, the reachable area RA1 can be determined to locate around the right-bottom corner COR of the graphic user interface 122.

Reference is further made to FIG. 7B, which is a schematic diagram illustrating the interaction layout 124c allocated and scaled according to the reachable area RA1 in FIG. 7A in some embodiments. Step S220 is executed by the controller 140, to allocate the interaction layout 124c within the graphic user interface 122 according to the reachable area RA1 corresponding to the continuous contact trace TR1. As shown in FIG. 7B, the interaction layout 124c is moved from a default position (e.g., the position of the interaction layout 124a shown in FIG. 3A) to an updated position corresponding to the reachable area RA1. In this case, the interaction layout 124c at the updated position is allocated by the controller 140 to overlap with the reachable area RA1. In other words, the interaction layout 124c is allocated to be adjacent to the right-bottom corner COR of the graphic user interface 122 according to the reachable area RA1.

Step S230 is executed by the controller 140, to scale the size configuration of the interaction layout 124c within the graphic user interface 122 according to the reachable area RA1 corresponding to the continuous contact trace TR1. The size configuration of the interaction layout 124c is scaled in positively correlated with the reachable area RA1. If the reachable area RA1 occupies a larger area, the size configuration of the interaction layout 124c is scaled up (enlarged) accordingly. On the other hand, if the reachable area RA1 occupies a smaller area, the size configuration of the interaction layout 124c is scaled down (shrunk) accordingly.

It is noticed that, as shown in FIG. 7B, the interaction layout 124c has five functional keys FK1-FK5. During scaling the size configuration in step S230, the controller 140 further detects overlapping ratios between each one of the function keys FK1-FK5 and the reachable area RA1.

As shown in FIG. 7B, the overlapping ratio between the function key FK1 and the reachable area RA1 is about 45%; the overlapping ratio between the function key FK2 and the reachable area RA1 is about 70%; the overlapping ratio between the function key FK3 and the reachable area RA1 is about 96%; the overlapping ratio between the function key FK4 and the reachable area RA1 is about 100%; the overlapping ratio between the function key FK5 and the reachable area RA1 is about 96%. In some embodiments, it is desired that the overlapping ratios are in a ranged between a lower threshold value and 100%. In some embodiments, the lower threshold value can be configured at 20%, 30% or 40%.

In some embodiments, in response to one of the overlapping ratios is lower than a threshold value, the controller 140 will further scale down the size configuration of the interaction layout, so as to increase the overlapping ratios.

It is noticed that, in some embodiments, the overlapping ratios are not required to be 100%. Reference is further made to FIG. 7C, which is a schematic diagram illustrating the interaction layout 124d in some embodiments. As shown in FIG. 7C, the interaction layout 124d is further scaled down (smaller than the interaction layout 124c in FIG. 7B), and the whole interaction layout 124d is covered by the reachable area RA1. In this case, the overlapping ratios between the function keys FK1-FK5 and the reachable area RA1 are equal to 100%. However, in this case, sizes of the function key FK1-FK5 are further reduced. As shown in FIG. 7C, the function key FK1 is now scaled to a relatively smaller size. When the user wants to press on the function key FK1, the user may accidentally press on other keys around the function key FK1. In order to avoid this situation, in response to a minimum size of the function keys FK1-FK5 being lower a threshold size (e.g., 100 pixels), the controller 140 is configured to scale up the size configuration of the interaction layout 124d.

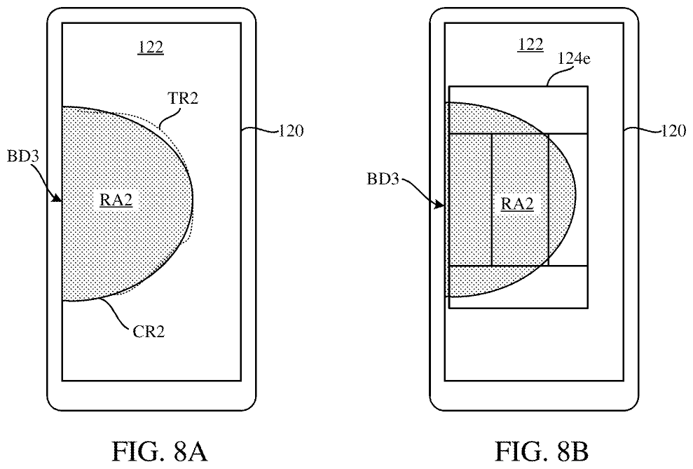

It is assumed that the continuous contact trace TR2 in FIG. 5B is tracked by the touch display panel 120 in step S210. In this case, the controller 140 is configured to draw another reachable area based on the continuous contact trace TR2. Reference is further made to FIG. 8A, which is a schematic diagram illustrating the reachable area RA2 determined by the controller 140 corresponding to the continuous contact trace TR2 in FIG. 5B.

As shown in FIG. 8A, in some embodiments, the reachable area RA2 is determined by fitting the continuous contact trace TR2 into a circular curve CR2 and extending the circular curve CR2 to a boundary BD3 of the graphic user interface 122 to form a closed loop. In this case, two ends of the circular curve CR1 is extended to the left boundary BD3 of the graphic user interface 122. An area within the closed loop is determined as the reachable area RA2. In this case, according to the continuous contact trace TR2, the reachable area RA2 can be determined to locate around a center level on the left boundary BD3 of the graphic user interface 122.

Reference is further made to FIG. 8B, which is a schematic diagram illustrating the interaction layout 124e allocated and scaled according to the reachable area RA2 in FIG. 8A in some embodiments. Step S220 is executed by the controller 140, to allocate the interaction layout 124e within the graphic user interface 122 according to the reachable area RA2 corresponding to the continuous contact trace TR2. As shown in FIG. 8B, the interaction layout 124e is moved to an updated position corresponding to the reachable area RA2. In this case, the interaction layout 124e at the updated position is allocated by the controller 140 to overlap with the reachable area RA2. In other words, a left edge of the interaction layout 124e is allocated to align with the left boundary BD3 of the graphic user interface 122 according to the reachable area RA2.

Step S230 is executed by the controller 140, to scale the size configuration of the interaction layout 124e within the graphic user interface 122 according to the reachable area RA2 corresponding to the continuous contact trace TR2. The size configuration of the interaction layout 124e is scaled in positively correlated with the reachable area RA2. If the reachable area RA2 occupies a larger area, the size configuration of the interaction layout 124e is scaled up (enlarged) accordingly. On the other hand, if the reachable area RA2 occupies a smaller area, the size configuration of the interaction layout 124e is scaled down (shrunk) accordingly.

As shown in FIG. 7A, FIG. 7B, FIG. 8A and FIG. 8B, based on different locations of the reachable area RA1/RA2 (determined from different continuous contact traces TR1 and TR2), the interaction layout 124c/124e are allocated at different positions on the graphic user interface 122. In this case, when the user hold the electronic device 100 in different manners, the interaction layout 124c/124e can be allocated to a proper position corresponding to the reachable area of the finger FNG.

In addition, the size configuration of the interaction layout 124c/124e can be adjusted according to the reachable area of the finger FNG. When the user has a longer finger, the interaction layout 124c/124e can be scaled up correspondingly. When the user has a shorter finger, the interaction layout 124c/124e can be scaled down correspondingly. The interaction layout 124c/124e can be adjusted to a suitable size based on the length of the finger FNG.

In aforesaid embodiments shown in FIG. 6, the control method 200b allocates and scales the interaction layout according to the reachable area. However, this disclosure is not limited thereto.

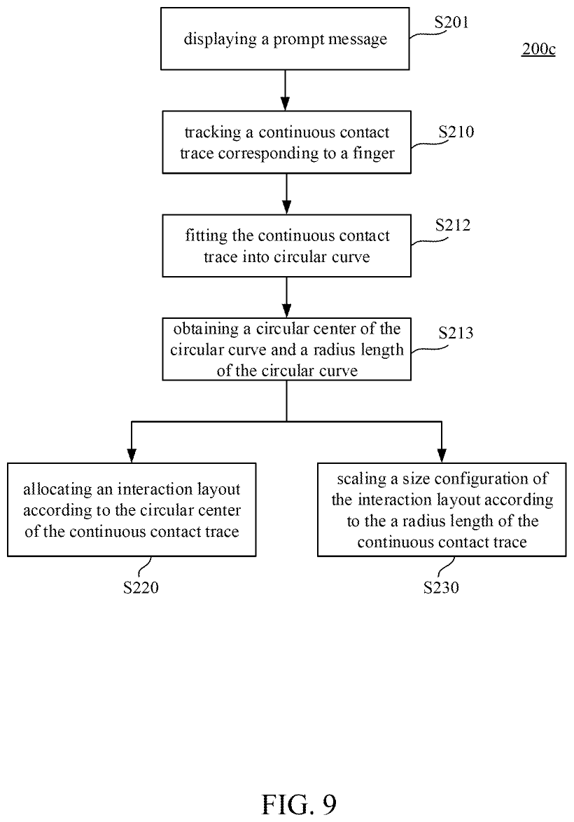

Reference is further made to FIG. 9, which is a flowchart illustrating a control method 200c according to some embodiments of the disclosure. The control method 200c in FIG. 9 illustrates an exemplary approach to perform the control method 200a in FIG. 4. The steps S201 and S210 in the control method 200c in FIG. 9 are similar to the steps S201 and S210 as discussed above. As shown in FIG. 9, after step S210, steps S212 and S213 are executed by the controller 140 to analyze the continuous contact trace (e.g., TR1, TR2 or TR3).

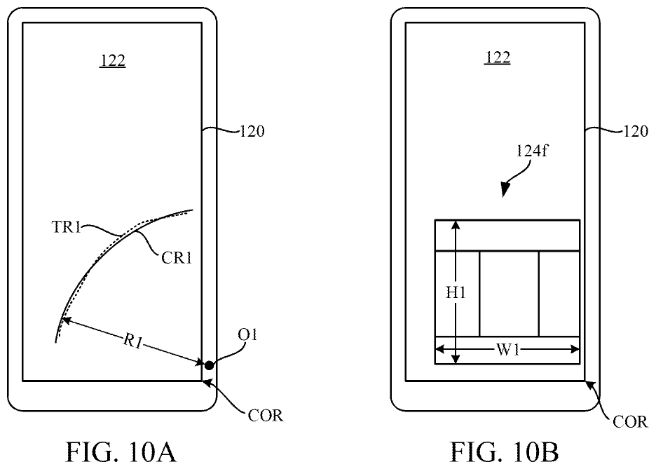

It is assumed that the continuous contact trace TR1 in FIG. 5A is tracked by the touch display panel 120 in step S210. In this case, in step S212, the controller 140 is configured to fit the continuous contact trace TR1 into a circular curve. Reference is further made to FIG. 10A, which is a schematic diagram illustrating the circular curve CR1 corresponding to the continuous contact trace TR1.

As shown in FIG. 10A, in some embodiments, the continuous contact trace TR1 is fitted by the controller 140 into a circular curve CR1. In some embodiments, the continuous contact trace TR1 can be into the circular curve CR1 based on a curve-fitting algorithm. In step S213, as shown in FIG. 10A, the controller 140 is configured to obtain a circular center O1 of the circular curve CR1 and a radius length R1 of the circular curve CR1. In this case, the circular center O1 is located adjacent to a corner COR of the graphic user interface 122.

Reference is further made to FIG. 10B, which is a schematic diagram illustrating the interaction layout 124f allocated and scaled according to the circular center O1 and the radius length R1 in FIG. 10A in some embodiments. Step S220 is executed by the controller 140, to allocate the interaction layout 124f within the graphic user interface 122 adjacent to the circular center O1 of the circular curve CR1. As shown in FIG. 10B, the circular center O1 is located adjacent to the corner COR of the graphic user interface 122. Therefore, the interaction layout 124f is also located adjacent to the corner COR of the graphic user interface 122.

In other words, the interaction layout 124f is allocated to be adjacent to the right-bottom corner COR of the graphic user interface 122 according to the circular center O1 of the circular curve CR1.

Step S230 is executed by the controller 140, to scale the size configuration of the interaction layout 124f within the graphic user interface 122 according to the radius length R1 of the circular curve CR1 corresponding to the continuous contact trace TR1. The size configuration of the interaction layout 124f is scaled in positively correlated with the radius length R1. As shown in FIG. 10B, the size configuration of the interaction layout 124f includes a total width W1 and a total height H1 of the interaction layout 124f. When the circular center O1 is adjacent to the corner COR, the total width W1 and the total height H1 of the interaction layout 124f are both scaled in reference with the radius length R1. For example, the total width W1 and the total height H1 can be scaled to be equal to the radius length R1. In this case, when the radius length R1 is longer, the interaction layout 124f will be scaled up (enlarged). When the radius length R1 is shorter, the interaction layout 124f will be scaled down (shrunk).

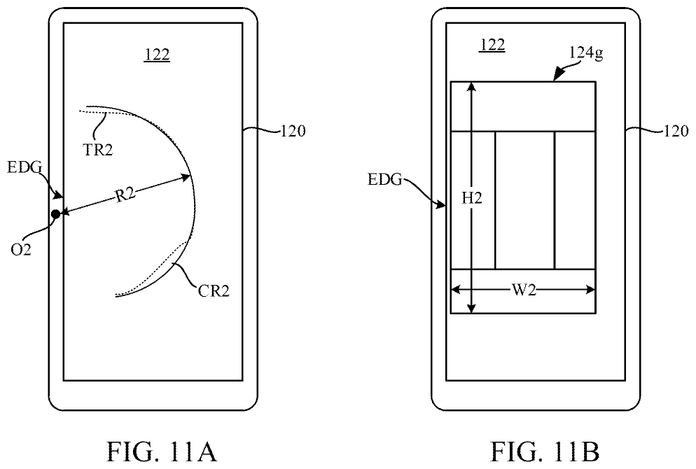

It is assumed that the continuous contact trace TR2 in FIG. 5B is tracked by the touch display panel 120 in step S210. In this case, in step S212, the controller 140 is configured to fit the continuous contact trace TR2 into a circular curve. Reference is further made to FIG. 11A, which is a schematic diagram illustrating the circular curve CR2 corresponding to the continuous contact trace TR2.

As shown in FIG. 11A, in some embodiments, the continuous contact trace TR2 is fitted by the controller 140 into another circular curve CR2. In some embodiments, the continuous contact trace TR2 can be into the circular curve CR2 based on a curve-fitting algorithm. In step S213, as shown in FIG. 11A, the controller 140 is configured to obtain a circular center O2 of the circular curve CR2 and a radius length R2 of the circular curve CR2. In this case, the circular center O2 is located adjacent to a center of a left edge EDG on the graphic user interface 122.

Reference is further made to FIG. 11B, which is a schematic diagram illustrating the interaction layout 124g allocated and scaled according to the circular center O2 and the radius length R2 in FIG. 11A in some embodiments. Step S220 is executed by the controller 140, to allocate the interaction layout 124g within the graphic user interface 122 according to the circular center O2 of the circular curve CR2 corresponding to the continuous contact trace TR2. As shown in FIG. 11B, the interaction layout 124g is moved to an updated position adjacent to the circular center O2. In this case, the interaction layout 124g at the updated position is allocated by the controller 140 to be adjacent to the circular center O2. In other words, a left edge of the interaction layout 124g is allocated to align with the left edge EDG of the graphic user interface 122 as shown in FIG. 11B.

Step S230 is executed by the controller 140, to scale the size configuration of the interaction layout 124g within the graphic user interface 122 according to the radius length R2 of the circular curve CR2 corresponding to the continuous contact trace TR2. The size configuration of the interaction layout 124g is scaled in positively correlated with the radius length R2. As shown in FIG. 11B, the size configuration of the interaction layout 124g includes a total width W2 and a total height H2 of the interaction layout 124g. When the circular center O2 is adjacent to the edge EDG, the total width W2 and the total height H2 of the interaction layout 124g are scaled in reference with the radius length R2. For example, the total width W2 can be scaled to be equal to the radius length R2 (i.e., W2=R2), and the total height H2 can be scaled to be equal to double of the radius length R2 (i.e., H2=2*R2). In this case, when the radius length R2 is longer, the interaction layout 124g will be scaled up (enlarged). When the radius length R2 is shorter, the interaction layout 124g will be scaled down (shrunk).

As shown in FIG. 10A to FIG. 11B, based on different locations of the circular centers, the interaction layout 124f/124g are allocated at different positions on the graphic user interface 122. In this case, when the user hold the electronic device 100 in different manners (e.g., holding with the right hand, holding with the left hand, holding vertically, holding horizontally), the interaction layout 124f/124g can be allocated to a proper position corresponding to the finger FNG.

In addition, the size configuration of the interaction layout 124f/124g can be adjusted according to the radius length R1/R2, which corresponds to the length of the finger FNG, such that the interaction layout 124f/124g can be adjusted to a suitable size based on the length of the finger FNG.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A control method, for controlling a graphic user interface displayed on a touch display panel, comprising:
tracking, by the touch display panel, a continuous contact trace corresponding to a finger on the touch display panel;
fitting the continuous contact trace into a circular curve;
allocating an interaction layout within the graphic user interface according to the circular curve; and
scaling a size configuration of the interaction layout within the graphic user interface according to the circular curve.

2. The control method of claim 1, further comprises:
obtaining a circular center of the circular curve and a radius length of the circular curve,
wherein the interaction layout is allocated adjacent to the circular center of the circular curve, and the size configuration of the interaction layout is scaled in positively correlated with the radius length of the circular curve.

3. The control method of claim 2, wherein the interaction layout is in a rectangular shape, the size configuration comprises a total width and a total height of the interaction layout, the control method comprises:
in response to the circular center being adjacent to a corner of the graphic user interface, allocating the interaction layout around the corner, scaling the total width in reference with the radius length, and scaling the total height in reference with the radius length.

4. The control method of claim 2, wherein the interaction layout is in a rectangular shape, the size configuration comprises a total width and a total height of the interaction layout, the control method comprises:
in response to the circular center being adjacent to an edge of the graphic user interface, allocating the interaction layout along the edge, scaling the total width in reference with the radius length, and scaling the total height in reference with double of the radius length.

5. The control method of claim 1, further comprising:
determining a reachable area of the finger on the graphic user interface according to the continuous contact trace,
wherein the interaction layout is allocated to overlap with the reachable area, and the size configuration of the interaction layout is scaled in positively correlated with the reachable area.

6. The control method of claim 5, wherein the reachable area is determined by fitting the continuous contact trace into the circular curve and extending the circular curve to a boundary of the graphic user interface to form a closed loop of the reachable area.

7. The control method of claim 5, wherein the interaction layout comprises a plurality of function keys, the control method further comprises:
during scaling the size configuration, detecting an overlapping ratio between one of the function keys and the reachable area;
in response to the overlapping ratio being lower than a threshold value, scaling down the size configuration of the interaction layout; and
in response to a minimum size of the function keys being lower than a threshold size, scaling up the size configuration of the interaction layout.

8. The control method of claim 1, further comprising:
displaying a prompt message on the graphic user interface about moving the finger to draw a reachable boundary before tracking the continuous contact trace.

9. An electronic device, comprising:
a touch display panel, configured to display a graphic user interface and track a continuous contact trace corresponding to a finger; and
a controller, coupled with the touch display panel, wherein the controller is configured to fit the continuous contact trace into a circular curve, allocate an interaction layout within the graphic user interface according to the circular curve, the controller is configured to scale a size configuration of the interaction layout within the graphic user interface according to the circular curve.

10. The electronic device of claim 9, wherein the controller is configured to obtain a circular center of the circular curve and a radius length of the circular curve, the interaction layout is allocated adjacent to the circular center of the circular curve, and the size configuration of the interaction layout is scaled in positively correlated with the radius length of the circular curve.

11. The electronic device of claim 10, wherein the interaction layout is in a rectangular shape, the size configuration comprises a total width and a total height of the interaction layout,
in response to the circular center being adjacent to a corner of the graphic user interface, the controller is configured to allocate the interaction layout around the corner, to scale the total width in reference with the radius length, and to scale the total height in reference with the radius length.

12. The electronic device of claim 10, wherein the interaction layout is in a rectangular shape, the size configuration comprises a total width and a total height of the interaction layout,
in response to the circular center being adjacent to an edge of the graphic user interface, the controller is configured to allocate the interaction layout along the edge, to scale the total width in reference with the radius length, and to scale the total height in reference with double of the radius length.

13. The electronic device of claim 9, wherein the controller is configured to determine a reachable area of the finger on the graphic user interface according to the continuous contact trace, wherein the interaction layout is allocated to overlap with the reachable area, and the size configuration of the interaction layout is scaled in positively correlated with the reachable area.

14. The electronic device of claim 13, wherein the controller determines the reachable area by fitting the continuous contact trace into the circular curve and extending the circular curve to a boundary of the graphic user interface to form a closed loop of the reachable area.

15. The electronic device of claim 13, wherein the interaction layout comprises a plurality of function keys, the controller is configured to detect an overlapping ratio between one of the function keys and the reachable area during scaling the size configuration,
in response to the overlapping ratio being lower than a threshold value, the controller is configured to scale down the size configuration of the interaction layout.

16. The electronic device of claim 9, wherein the touch display panel is configured to display a prompt message on the graphic user interface about moving the finger to draw a reachable boundary before tracking the continuous contact trace.

17. A non-transitory computer readable storage medium with a computer program to execute a control method for controlling a graphic user interface displayed on a touch display panel, wherein the control method comprises:
tracking a continuous contact trace corresponding to a finger on the touch display panel;
fitting the continuous contact trace into a circular curve;
allocating an interaction layout within the graphic user interface according to the circular curve; and
scaling a size configuration of the interaction layout within the graphic user interface according to the circular curve.

18. The non-transitory computer readable storage medium of claim 17, wherein the control method further comprises:
obtaining a circular center of the circular curve and a radius length of the circular curve,
wherein the interaction layout is allocated adjacent to the circular center of the circular curve, and the size configuration of the interaction layout is scaled in positively correlated with the radius length of the circular curve.

19. The non-transitory computer readable storage medium of claim 17, wherein the control method further comprises:
determining a reachable area of the finger on the graphic user interface according to the continuous contact trace,
wherein the interaction layout is allocated to overlap with the reachable area, and the size configuration of the interaction layout is scaled in positively correlated with the reachable area.

20. The non-transitory computer readable storage medium of claim 19, wherein the reachable area is determined by fitting the continuous contact trace into the circular curve and extending the circular curve to a boundary of the graphic user interface to form a closed loop of the reachable area.
